(19) United States
(12) Patent Application Publication
(10) Pub. No.: US 2008/0189876 A1
(43) Pub. Date: Aug. 14, 2008

(54) Multistep hair color revitalizing kit and associated methods

(76) Inventors: David Leigh Trigg, Mason, OH (US); Jason Lee Jones, Monroe, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/705,615

(22) Filed: Feb. 12, 2007

(51) Int. Cl. A61Q 5/10

(52) U.S. Cl. 8/405; 8/426

(57) ABSTRACT

A hair treatment kit suitable for application as a multistep hair color revitalizing product is disclosed. The kit contains:
(a) a first composition containing a temporary dye, a semipermanent hair dye, or a mixture thereof,
(b) a second composition containing a silicone hair glossing agent, and labeling having indicia instructing a topical application of the second composition to hair after a topical application of the first composition to the hair.

### FIELD OF THE INVENTION

The present invention relates to a hair treatment kit for use as a multistep hair color revitalizing product. More particularly, the hair treatment kit comprises (a) a first composition comprising a hair dye, (b) a second composition comprising a hair glossing agent, and (c) labeling instructing a topical application of the second composition to hair after a topical application of the first composition.

### BACKGROUND OF THE INVENTION

Individuals often wish to cosmetically alter the color of their hair. Some individuals treat their own hair using currently available hair dye compositions to provide a desired hair color. Other individuals rely upon a professional to change their hair color.

Three general categories of hair colorants are available to consumers and professionals, generally distinguished by the length of time the color remains on the hair. One category is the temporary colorants. These colorants are deposited on the hair with no penetration into the cortex and are removed from the hair by the first shampooing after application. The dyes in the temporary colorants have a minimal affinity for the hair and often are used for a specific event or occasion.

A second category of hair colorants is the semipermanent colorants. These colorants penetrate the hair cuticle, diffuse throughout the cortex, and therefore resist several shampooings. Semipermanent hair colorants often are used by individuals dyeing their hair for the first time, especially because the semipermanent colorants effectively color gray hair, require no mixing, and contain no peroxide or ammonia. Semipermanent colorants usually impart a color sufficient to last for at least 24 shampooings.

The third category of hair colorants is the permanent colorants. This category of colorants predominate the market because permanent dyes provide the most effective hair coloration and maximum flexibility. When using permanent colorants, an uncolored precursor diffuses into the hair and is subjected to oxidation reactions, typically by the addition of hydrogen peroxide, to produce the desired color within the hair.

Permanent dyeing is expensive and time consuming. Moreover, the chemicals employed in permanent dyeing can damage the hair. Therefore, frequent use of permanent dye, e.g., weekly, is not recommended, but rather typically are applied at intervals of at least about one month or longer.

It is unavoidable that the color of hair dyed with a semipermanent or permanent dye gradually fades after application due to the effects of shampoo, sweat, ultraviolet rays, and the like. The gradual fading of color results in a reduction the satisfaction an individual generally feels immediately after dyeing.

Individuals who have had their hair dyed typically desire to prolong the effects of the color treatment for as long as possible in order to maintain the esthetic effects of the dye, avoid hair damage, and abate the cost of hair dyeing. One way of prolonging the esthetic effects of a hair coloring treatment is to use hair color maintenance shampoos, conditioners, rinses, mousses, gels, sprays, and the like. Such hair color maintenance products are referred to as hair color revitalizers, and typically are formulated with a temporary dye, a semipermanent dye, or mixture thereof to assist in prolonging the duration of the coloring treatment.

Hair color revitalizing products are available in a variety of forms, such as shampoos, conditioners, or sets thereof, which are designed for daily or weekly use on previously dyed hair. Hair color revitalizers are formulated to have essentially the same color as the dyed hair, but revitalizers have drawbacks, for example, adversely effecting other esthetic hair properties.

Another hair care treatment is the application of a gloss composition to the hair. Glosses typically are silicone-containing compositions that are applied to the hair on a regular, i.e., daily, basis. Gloss products are not rinsed from the hair, but remain on the hair to impart a shine to the hair. Gloss compositions do not add color to hair, but provide a visual esthetic effect.

It is known that color fading of dyed hair is caused primarily by shampooing, which results in a washing out of certain color components of a hair dye. In particular, some coloring components are more easily washed from of the hair during shampooing. This washing out causes both fading and a change of tone of dyed hair. The application of a hair color revitalizer often fails to return the hair to the hair color immediately after dyeing. The present invention provides a method of revitalizing hair to a color more closely to the hair color immediately after dyeing. The present method also helps overcome the problem of insufficient color generation and esthetics provided by present day hair color revitalizers.

### SUMMARY OF THE INVENTION

The present invention is directed to a method of restoring dyed hair to an esthetically acceptable color. More particularly, the present invention is directed to a multistep hair treatment wherein the hair first is treated with a composition comprising a temporary dye, semipermanent dye, or a mixture thereof, followed by a treatment with a glossing composition comprising a silicone.

Accordingly, one aspect of the present invention is to provide a method of revitalizing hair color to compensate for the gradual fading of hair color observed after a prior hair color treatment.

Another aspect of the present invention is to provide a hair treatment kit suitable for application as a multistep hair color revitalizing product. The kit comprises:

(a) a first composition comprising a temporary dye, a semipermanent hair dye, or a mixture thereof, and
(b) a second composition comprising a silicone hair glossing agent.

The kit also contains labeling and instructions for use of the first and second compositions, wherein the second composition is topically applied to the hair after the first composition is typically applied to the hair.

Still another aspect of the present invention is to enhance the color provided by a hair color revitalizing composition by application of a hair gloss composition to the hair after an application of a hair color revitalizing composition. The hair color revitalizing composition and the hair gloss composition act synergistically to enhance the color of the hair and improve the overall esthetics of the hair.

### BRIEF DESCRIPTION OF THE FIGURES

FIG. 1 is a schematic visually illustrating the L*a*b color space; and

FIGS. 2 and 3 schematically illustrate the synergistic effect of a sequential hair treatment of the present invention.

### DETAILED DESCRIPTION OF THE PREFERRED EMBODIMENTS

The present invention relates to a hair treatment kit suitable for application as a multistep hair color revitalizing product. The components of the kit are described below, including various optional and preferred components of the present invention.

All percentages and ratios are calculated on a weight basis, unless otherwise indicated. All molar weights are weight average molecular weights and are given in units of grams per mole.

All ingredient amounts are on an active ingredient basis, exclusive of solvents, extenders, carriers, by-products, and other inactive components, that may be present in commercially available sources, unless otherwise indicated.

All measurements made are at ambient room temperature, which is about 73° F. (25° C.), unless otherwise designated.

The term “daily” means once per 24 hour period. The term “weekly” means once in a period of seven consecutive days.

All ranges disclosed herein, i.e., C₁-C₃₀, C₂-C₃₀, C₁-C₆, C₉-C₂₂, C₁₂-C₁₄, C₃-C₆, C₂-C₆, C₇-C₄₀, C₄-C₂₀, C₈-C₃₀ and C₁-C₁₀, include the terminal limits of each range and each embodiment and subrange within the disclosed range. For example, C₁-C₁₀, includes C₁, C₂, C₃, C₄, C₅, C₆, C₇, C₈, C_{g}, C₁₀. The disclosed range also includes the subranges of C₂-C₁₀, C₃-C₁₀, C₄-C₁₀, C₅-C₁₀, C₆-C₁₀, C₇-C₁₀, C₈-C₁₀, C₁-C₉, C₂-C₉, C₃-C₉, C₄-C₉, C₅-C₉, C₆-C₉, C₇-C₉, C₁-C₈, C₂-C₈, C₃-C₈, C₄-C₈, C₅-C₈, C₆-C₈, C₁-C₇, C₂-C₇, C₃-C₇, C₄-C₇, C₅-C₇, C₁-C₆, C₂-C₆, C₃-C₆, C₄-C₆, C₁-C₅, C₂-C₅, C₃-C₅, C₁-C₄, C₂-C₄, and C₁-C₃. Similarly, if “n” is defined as 1-10, this disclosure includes n=1, 2, 3, 4, 5, 6, 7, 8, 9, 10, 2-10, 3-10, 4-10, 5-10, 6-10, 7-10, 8-10, 1-9, 2-9, 3-9, 4-9, 5-9, 6-9, 7-9, 1-8, 2-8, 3-8, 4-8, 5-8, 6-8, 1-7, 2-7, 3-7, 4-7, 5-7, 1-6, 2-6, 3-6, 4-6, 1-5, 2-5, 3-5, 1-4, 2-4, and 1-3.

All documents referred to herein, including patents, patent applications, and printed publications, are incorporated herein by reference in their entirety.

### Hair Treatment Kit

A hair treatment kit of the present invention comprises (a) a first composition comprising a temporary hair dye, a semipermanent hair dye, or a mixture thereof, (b) a second composition comprising a silicone hair glossing agent, and (c) labeling instructing that the second composition is topically applied to the hair after the first composition is topically applied to the hair. The hair treatment kit can further comprise optional additional compositions, such as one or more of a hair shampoo, a hair conditioner, a hair spray, a mousse, a hair gel, and similar hair treatment products.

The kit comprises containers for packaging the first and second composition, and labeling containing instructions for use of the first and second compositions. The kit can contain one or a plurality of containers of the first and/or second composition.

### First Hair Color Revitalizing Composition

The first composition of a presently claimed kit is topically applied to the hair of an individual to improve or enhance the color of the hair. The treated hair can be previously-dyed hair, including oxidatively-dyed hair, or can be undyed hair. Typically, the hair has been dyed previously, and the first composition of the kit is applied to help maintain hair color and/or help restore faded hair color. The first composition enriches color by replacing or adding to faded color elements and by eliminating dull tones. The first composition is non-damaging to the hair and helps return the hair to the original dyed color tone.

The first hair color revitalizing composition can be in any form known in the art. For example, the first composition can be in the form of a shampoo, conditioner, or shampoo/conditioner, which colors the hair when applied thereto. Regardless of the form of the first composition, in preferred methods of the present invention, the hair first is shampooed prior to treatment with first composition.

An essential ingredient of the first composition is a temporary hair dye, a semipermanent hair dye, or mixture thereof. The identity of the temporary hair dye and the semipermanent hair dye is not limited, and can be any temporary or semipermanent hair dye known or used in the art. Dyes useful in the first composition can be a direct dye, a disperse dye, an acid dye, a basic dye, or mixtures thereof. The temporary and/or semipermanent hair dye typically is present in the first composition in an amount of about 0.01% to about 0.1%, preferably about 0.02% to about 0.8%, and more preferably about 0.05% to about 0.5%, by weight of the first composition. In preferred embodiments, the first composition comprises a mixture of temporary dyes, a mixture of semipermanent dyes, or a mixture of temporary and semipermanent dyes.

Temporary dyes useful in the first composition typically are monoazo, diazo, polyazo, quinoline, anthraquinone, triphenylmethane, or naphthoquinoneimine dyes. Exemplary temporary dyes include, but are not limited to Acid Yellow 3, Acid Orange 7, Acid Orange 24, Direct Red 80, Food Red 1, Acid Red 33, Acid Violet 43, Acid Blue 9, Acid Green 25, Direct Black 57, Basic Yellow 57, Basic Yellow 87, Basic Red 76, Basic Red 51, Basic Blue 99, Basic Brown 16, Basic Brown 17, Acid Yellow 1, Acid Yellow 9, Disperse Yellow 3, Disperse Yellow 1, Basic Violet 1, Basic Violet 3, FD&C Blue No. 1, FD&C Red No. 4, FD&C Yellow No. 5, FD&C Yellow No. 6, FD&C Green No. 3, FD&C Red No. 40, D&C Green No. 3, D&C Orange No. 5, D&C Red No. 6, D&C Red No. 7, D&C Red No. 22, D&C Red No. 28, D&C Red No. 30, D&C Red No. 33, D&C Red No. 34, D&C Red No. 36, D&C Orange No. 4, D&C Yellow No. 10, D&C Green No. 8, Ext. D&C Violet No. 2, Ext. D&C Yellow No. 7, salts thereof, and mixtures thereof.

Semipermanent dyes typically are a nitrophenylenediamine or a nitroaminophenolic ether, illustrated as compounds (1) and (2), respectively, wherein R¹ through R⁴ typically are hydrogen, alkyl, hydroxyalkyl, or polyhydroxyalkyl.

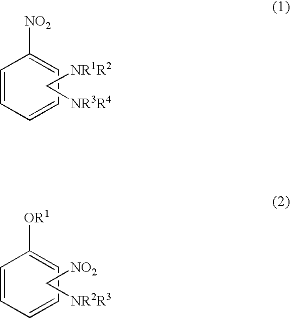

The semipermanent dye also can be an aminoanthraquinone.

Nonlimiting examples of semipermanent hair dyes include 2-hydroxyethyl picramic acid, 4-nitro-m-phenylenediamine, HC Yellow 10, 4-nitro-o-phenylenediamine, HC Blue 7, HC Yellow 2, HC Yellow 5,2-nitro-p-phenylenediamine, HC Red 14, HC Red 10, HC Red 11, HC Red 1, HC Red 3, HC Red 13, N,N-bis(2-hydroxyethyl)-2-nitro-p-phenylenediamine, HC Violet 2, HC Blue 2,2-amino-4-nitrophenol, 2-amino-5-nitrophenol, HC Yellow 4, HC Yellow 9, 2-nitro-5-glycerylmethylaniline, 2-amino-3-nitrophenol, 2-nitro-N-hydroxyethyl-p-anisidine, HC Orange 2, HC Orange 3,4-amino-3-nitrophenol, 4-hydroxypropylamino-3-nitrophenol, 3-nitro-p-hydroxyethylaminophenol, Disperse Red 15, Disperse Red 11, Disperse Violet 1, Disperse Violet 4, Disperse Blue 3, HC Blue 14, HC Yellow 6, HC Yellow 15, HC Yellow 1, HC Orange 1, HC Yellow 7, Disperse Black 9, salts thereof, and mixtures thereof.

Additional temporary and semipermanent dyes useful alone, or in any combination, or as a salt, in first hair color revitalizing composition include, but are not limited to, Acid Black 131, Acid Blue 62, Acid Orange 3, Acid Red 35, Acid Red 52, 2-amino-6-chloro-4-nitrophenol, 4-amino-2-hydroxytoluene, 2-amino-3-nitrophenol, m-aminophenol, o-aminophenol, p-aminophenol, Basic Blue 6, Basic Blue 9, Basic Blue 41, Basic Brown 4, Basic Red 22, Basic Yellow 11, N,N-bis(2-hydroxyethyl)-p-phenylenediamine sulfate, bismuth citrate, 2-chloro-p-phenylenediamine, 2,4-diaminodiphenylamine, 4,4′-diaminodiphenylamine, 2,4-diaminophenol, 2,4-diaminophenoxyethanol, 2,6-diaminopyridine, N,N-diethyl-m-aminophenol, N,N′-dimethyl-N-hydroxyethyl-3-nitro-p-phenylenediamine, dimethyl o-toluidine, 2,5-dinitrophenol, Direct Black 51, Direct Red 23, Direct Red 81, Direct Yellow 48, Direct Violet 48, Direct Yellow 12, Disperse Blue 1, HC Blue No. 4, HC Blue No. 5, HC Yellow No. 3, HC Yellow No. 5, henna, hydroxybenzomorpholine, N-hydroxyethyl-2-amino-4-hydroxytoluene sulfate, 2-hydroxyethylamino-5-nitroanisole, lead acetate, N-methoxyethyl-p-phenylenediamine, 2-methoxyethyl-p-phenylenediamine, 2-methoxyethyl-p-phenylenediamine, 2-methoxy-p-phenylenediamine, 4-methoxytoluene-2,5-diamine, 3-methylamino-4-nitrophenoxyethanol, p-methylaminophenol, 2-methyl-5-hydroxyethylaminophenol, N-methyl-2-nitro-p-phenylenediamine, 2-methylresorcinol, 1,5-naphthalenediol, 2,3-naphthalenediol, 2,7-naphthalenediol, 1-naphthol, 2-naphthol, 3-nitro-4-aminophenoxyethanol, 2-nitro-N-hydroxyethyl-p-anisidine, m-phenylenediamine, p-phenylenediamine, phenyl methylpyrazolone, N-phenyl-p-phenylenediamine, phloroglucinol, picramic acid, Pigment Blue 15, Pigment Blue 15:2, Pigment Green 7, Pigment Red 112, Pigment Violet 19, Pigment Yellow 1, Pigment Yellow 3, Pigment Yellow 12, Pigment Yellow 13, Pigment Yellow 73, pyrocatechol, pyrogallol, resorcinol, sodium picramate, sodium sulfanilate, Solvent Black 3, Solvent Blue 35, Solvent Red 24, Solvent Yellow 44, toluene-2,5-diamine, toluene-3,4-diamine, salts thereof, and mixtures thereof. Further dyes useful in the first hair color revitalizing composition are disclosed in U.S. Pat. Nos. 6,746,492 and 6,835,018, each incorporated herein by reference.

The first composition can contain a mixture of a temporary dye and a semipermanent dye. In some embodiments, a combination of a temporary dye and a semipermanent dye helps provide more consistent color results from the root to the tip of the hair both during the initial hair color revitalizing process and after subsequent shampooings. Because the size of the hair is not uniform from root to tip the semipermanent dyes will diffuse both at the root and tip, but are not retained within the tip, whereas the temporary dye generally diffuses only into the tips of the hair, the combination of dyes improves the overall hair color revitalizing.

In addition to the temporary and/or semipermanent dye, the first composition comprises a cosmetically-acceptable carrier. The cosmetically-acceptable carrier typically comprises water. The carrier can further comprise an alcohol, such as ethanol, or a diol, polyol, such as propylene glycol. Other useful carriers include, but are not limited to, benzyl alcohol, isopropyl alcohol, butyl alcohol, pentanol, ethoxyethanol, inositol, mannitol, butylenes glycol, ethylene glycol, ethoxydiglycol, polyethylene glycol having 4 to 250 repeating ethylene glycol units, γ-butyrolactone, N-methylpyrrolidone, propylene carbonate, and mixtures thereof. The first composition of the present invention typically comprises about 5% to about 99%, preferably about 10% to about 98%, and most preferably, about 10% to about 97%, by weight of the composition, of a carrier.

The first composition of the present invention can contain a variety of other components that are conventionally used in a given product type, provided that they do not adversely affect the benefits of the invention. These optional components are suitable for application to the hair, that is, when incorporated into compositions for which they are designed, and can be used in contact with human hair and skin without undue toxicity, incompatibility, instability, allergic response, and the like, within the scope of sound medical or formulator judgment. The CTFA Cosmetic Ingredient Handbook, Second Edition (1992) describes a wide variety of nonlimiting cosmetic and pharmaceutical ingredients commonly used in the hair care industry, which are suitable for use in a first composition of the present invention.

For example, if the first composition is designed as a hair color revitalizing shampoo, the composition can contain an anionic, nonionic, or amphoteric surfactant, or mixtures thereof, that conventionally are used in hair shampoo compositions.

Nonlimiting examples of surfactants suitable for use are described in McCutcheon's Emulsifiers and Detergents, 1989 Annual, published by M.C. Publishing Co., U.S. Pat. Nos. 3,929,678, 2,658,072, and 2,528,378, and U.S. Patent Publication No. 2003/0086896, each of which is incorporated herein by reference.

Nonlimiting anionic surfactants include ammonium lauroyl sarcosinate, sodium trideceth sulfate, sodium lauroyl sarcosinate, ammonium laureth sulfate, sodium laureth sulfate, ammonium lauryl sulfate, sodium lauryl sulfate, ammonium cocoyl isethionate, sodium cocoyl isethionate, sodium lauroyl isethionate, sodium cetyl sulfate, sodium monoalkyl phosphate, sodium cocoglyceryl ether sulfonate, sodium C₉-C₂₂ soap, and mixtures thereof. Nonlimiting nonionic surfactants include lauramine oxide, cocoamine oxide, decyl polyglucose, lauryl polyglucose, sucrose cocoate, C₁₂₋₁₄ glucosamides, sucrose laurate, and mixtures thereof. Nonlimiting cationic surfactants include fatty amines, di-fatty quaternary amines, tri-fatty quaternary amines, imidazolinium quaternary amines, and combinations thereof. Nonlimiting amphoteric surfactants include disodium lauroamphodiacetate, sodium lauroamphoacetate, cetyl dimethyl betaine, cocoamidopropyl betaine, cocoamidopropyl hydroxy sultaine, and mixtures thereof. Typical examples of surfactants include sodium lauryl sulfate, sodium lauryl ether sulfate, cocamidopropyl betaine, and mixtures thereof.

If the first composition is designed as a conditioner, the composition can contain any hair conditioning agent known in the industry either hydrophilic, hydrophobic, or a mixture of hydrophilic and hydrophobic agents. Nonlimiting examples of hydrophilic conditioning agents include polyhydric alcohols, polypropylene glycols, polyethylene glycols, ureas, pyrrolidone carboxylic acids, ethoxylated and/or propoxylated C₃-C₆ diols and triols, alpha-hydroxy C₂-C₆ carboxylic acids, ethoxylated and/or propoxylated sugars, polyacrylic acid copolymers, sugars having up to about 12 carbon atoms, sugar alcohols having up to about 12 carbon atoms, and mixtures thereof. Specific examples of useful hydrophilic conditioning agents include materials such as urea and guanidine; glycolic acid and glycolate salts (e.g., ammonium and quaternary alkyl ammonium); lactic acid and lactate salts (e.g., ammonium and quaternary alkyl ammonium); sucrose, fructose, glucose, eruthrose, erythritol, sorbitol, mannitol, glycerol, and hexanetriol; propylene glycol, butylene glycol, hexylene glycol, and the like; polyethylene glycols, such as PEG-2, PEG-3, PEG-30, PEG-50; polypropylene glycols, such as PPG-9, PPG-12, PPG-15, PPG-17, PPG-20, PPG-26, PPG-30, PPG-34; alkoxylated glucose; hyaluronic acid; cationic skin conditioning polymers (e.g., quaternary ammonium polymers, such as polyquaternium polymers); and mixtures thereof. Also useful are materials such as aloe vera in any of its variety of forms (e.g., aloe vera gel); chitosan and chitosan derivatives, e.g., chitosan lactate; lactamide monoethanolamine; acetamide monoethanolamine; and mixtures thereof. Also useful are propoxylated glycerols disclosed in U.S. Pat. No. 4,976,953, incorporated herein by reference.

Hydrophobic conditioning agents include mineral oil, petrolatum, lecithin, hydrogenated lecithin, lanolin, lanolin derivatives, C₇-C₄₀ branched chain hydrocarbons, C₁-C₃₀ alcohol esters of C₁-C₃₀ carboxylic acids, C₁-C₃₀ alcohol esters of C₂-C₃₀ dicarboxylic acids, monoglycerides of C₁-C₃₀ carboxylic acids, diglycerides of C₁-C₃₀ carboxylic acids, triglycerides of C₁-C₃₀ carboxylic acids, ethylene glycol monoesters of C₁-C₃₀ carboxylic acids, ethylene glycol diesters of C₁-C₃₀ carboxylic acids, propylene glycol monoesters of C₁-C₃₀ carboxylic acids, propylene glycol diesters of C₁-C₃₀ carboxylic acids, C₁-C₃₀ carboxylic acid monoesters and polyesters of sugars, polydialkylsiloxanes, polydiarylsiloxanes, polyalkarylsiloxanes, cyclomethicones having 3 to 9 silicon atoms, vegetable oils, hydrogenated vegetable oils, polypropylene glycol C₄-C₂₀ alkyl ethers, di C₈-C₃₀ alkyl ethers, and mixtures thereof.

Straight and branched chain hydrocarbons having about 7 to about 40 carbon atoms are useful hair conditioners. Nonlimiting examples of such hydrocarbons include dodecane, isododecane, tridecane, tetradecane, pentadecane, polybutene, squalane, hydrogenated polyisobutylene, docosane (i.e., a C₂₂ hydrocarbon), hexadecane, isohexadecane (a commercially available hydrocarbon sold as PERMETHYL® 101A by Presperse, South Plainfield, N.J.), C₇-C₄₀ isoparaffins, and polydecene (a branched liquid hydrocarbon is commercially available under the tradenames PURESYN 100® and PURESYN 3000® from Mobile Chemical, Edison, N.J.).

Nonlimiting examples of ester-type hair conditioners include diisopropyl sebacate, diisopropyl adipate, isopropyl myristate, isopropyl palmitate, myristyl propionate, ethylene glycol distearate, 2-ethylhexyl palmitate, isodecyl neopentanoate, di-2-ethylhexyl maleate, cetyl palmitate, myristyl myristate, stearyl stearate, cetyl stearate, behenyl behenrate, dioctyl maleate, dioctyl sebacate, diisopropyl adipate, cetyl octanoate, diisopropyl dilinoleate, carpylic/capric triglyceride, PEG-6 caprylic/capric triglyceride, PEG-8 caprylic/capric triglyceride, and mixtures thereof.

Nonlimiting examples of liquid C₁-C₃₀ monoesters and polyesters of sugars and related materials include glucose tetraoleate, the glucose tetraesters of soybean oil fatty acids (unsaturated), the mannose tetraesters of mixed soybean oil fatty acids, the galactose tetraesters of oleic acid, the arabinose tetraesters of linoleic acid, xylose tetralinoleate, galactose pentaoleate, sorbitol tetraoleate, the sorbitol hexaesters of unsaturated soybean oil fatty acids, xylitol pentaoleate, sucrose tetraoleate, sucrose pentaoletate, sucrose hexaoleate, sucrose hepatoleate, sucrose octaoleate, and mixtures thereof. Nonlimiting examples of solid esters of sugars include sorbitol hexaester wherein the carboxylic acid ester moieties are palmitoleate and arachidate in a 1:2 molar ratio; the octaester of raffinose wherein the carboxylic acid ester moieties are linoleate and behenate in a 1:3 molar ratio; the heptaester of maltose wherein the esterifying carboxylic acid moieties are sunflower seed oil fatty acids and lignocerate in a 3:4 molar ratio; the octaester of sucrose wherein the esterifying carboxylic acid moieties are oleate and behenate in a 2:6 molar ratio; and the octaester of sucrose wherein the esterifying carboxylic acid moieties are laurate, linoleate and behenate in a 1:3:4 molar ratio. A preferred solid ester is a sucrose polyester wherein the degree of esterification is 7-8, and wherein the fatty acid moieties are C₁₈ mono- and/or di-unsaturated and behenic, in a molar ratio of unsaturates: behenic of 1:7 to 3:5. A particularly preferred solid sugar polyester is the octaester of sucrose wherein about seven behenic fatty acid moieties and about one oleic acid moiety are in the molecule. Other esters include cottonseed oil or soybean oil fatty acid esters of sucrose. The ester materials are further described in U.S. Pat. No. 2,831,854, U.S. Pat. No. 4,005,196, U.S. Pat. No. 4,005,195, U.S. Pat. No. 5,306,516, U.S. Pat. No. 5,306,515, U.S. Pat. No. 5,305,514, U.S. Pat. No. 4,797,300, U.S. Pat. No. 3,963,699, U.S. Pat. No. 4,518,772, each incorporated herein by reference.

Vegetable oils and hydrogenated vegetable oils also are useful conditioners. Nonlimiting examples of vegetable oils and hydrogenated vegetable oils include safflower oil, castor oil, coconut oil, cottonseed oil, menhaden oil, palm kernel oil, palm oil, peanut oil, soybean oil, rapeseed oil, linseed oil, rice bran oil, pine oil, sesame oil, sunflower seed oil, hydrogenated safflower oil, hydrogenated castor oil, hydrogenated coconut oil, hydrogenated cottonseed oil, hydrogenated menhaden oil, hydrogenated palm kernel oil, hydrogenated palm oil, hydrogenated peanut oil, hydrogenated soybean oil, hydrogenated rapeseed oil, hydrogenated linseed oil, hydrogenated rice bran oil, hydrogenated sesame oil, hydrogenated sunflower seed oil, and mixtures thereof.

Nonlimiting examples of C₄-C₂₀ alkyl esters of polypropylene glycols, C₁-C₂₀ carboxylic acid esters of polypropylene glycols, and di-C₈-C₃₀ alkyl ethers include PPG-14 butyl ether, PPG-15 stearyl ether, dioctyl ether, dodecyl octyl ether, and mixtures thereof. Hydrophobic chelating agents described in U.S. Pat. No. 4,387,244, incorporated herein by reference, also are useful hydrophobic conditioning agents.

Nonvolatile silicones, such as polydialkylsiloxanes, polydiarylsiloxanes, and polyalkarylsiloxanes, also are useful conditioning agents. These silicones are disclosed, for example, in U.S. Pat. No. 5,069,897, incorporated herein by reference. The polyalkylsiloxanes correspond to the general chemical formula R₃SiO[R₂SiO]ₓSiR₃, wherein R is an alkyl group, preferably R is methyl or ethyl, and more preferably methyl, and x is an integer up to about 500, chosen to achieve the desired molecular weight. Commercially available polyalkylsiloxanes include the polydimethylsiloxanes, also known as dimethicones, nonlimiting examples of which include the VICASIL® series sold by General Electric Company and the Dow Corning® 200 series sold by Dow Corning Corporation. Specific examples of polydimethylsiloxanes include Dow Corning® 225 fluid having a viscosity of 10 centistokes and a boiling point greater than 200° C., and Dow Corning® 200 fluids having viscosities of 50, 350, and 12,500 centistokes, respectively, and boiling points greater than 200° C. Also useful is a trimethylsiloxysilicate, which is a polymeric material corresponding to the general chemical formula [(CH₂)₃SiO_{1/2}]ₓ[SiO₂]y, wherein x is an integer from about 1 to about 500 and y is an integer from about 1 to about 500. A commercially available trimethylsiloxysilicate is sold as a mixture with dimethicone as Dow Corning® 593 fluid. The dimethiconols, which are hydroxyl terminated dimethyl silicones represented by the general chemical formulas R₃SiO[R₂SiO]ₓSiR₂OH and HOR₂SiO[R₂SiO]ₓSiR₂OH wherein R is an alkyl group (preferably R is methyl or ethyl, more preferably methyl) and x is an integer up to about 500, chosen to achieve the desired molecular weight, also are useful conditioners. Commercial dimethiconols typically are sold as mixtures with dimethicone or cyclomethicone (e.g., Dow Corning® 1401, 1402, and 1403 fluids).

Additional useful conditioners are the polyalkylaryl siloxanes, with polymethylphenyl siloxanes having viscosities of about 15 to about 65 centistokes at 25° C. being preferred. These materials are available commercially, for example, as SF 1075 methylphenyl fluid (General Electric Company) and 556 Cosmetic Grade phenyl trimethicone fluid (Dow Corning Corporation). Alkylated silicones, such as methyldecyl silicone and methyloctyl silicone are useful and are commercially available from General Electric Company. Alkyl modified siloxanes, including alkyl methicones and alkyl dimethicones wherein the alkyl chain contains 10 to 50 carbon atoms also are useful. Such siloxanes are commercially available under the tradenames ABIL WAX 9810 (C₂₄-C₂₈ alkyl methicone) (Goldschmidt) and SF1632 (ceteraryl methicone) (General Electric Company). Cyclomethicone/dimethicone copolyol mixtures also are useful as formulation aid/conditioning agents. A suitable mixture is sold under the tradename DC 3225Q® from Dow Corning. Additional conditioning agents are disclosed in U.S. Patent Publication No. 2003/0086896, incorporated herein by reference.

Regardless of the product form of the first composition, the first composition can contain additional optional ingredients typically included in hair care compositions. Nonlimiting examples of such ingredients include emulsifiers, pH adjusting agents, preservatives, proteins, vitamins, fragrances, viscosity control agents, opacifying and/or pearlizing agents, humectants, suspending agents, chelating agents, antistatic agents, and similar ingredients.

For example, the chelating agent can be an aminopolycarboxylic acid, such as ethylenediaminetetraacetic acid or a salt thereof. Viscosity control agents include PEG-20 methyl glucose trioleate and sodium chloride. Preservatives include the parabens, e.g., methyl paraben and/or propyl paraben, phenoxyethanol, and sodium benzoate. The antistatic agent typically is a cationic or polycationic compound. The pH adjusting agent can be sodium hydroxide, potassium phosphate, potassium hydroxide, ammonium hydroxide, monoethanolamine, diethanolamine, triethanolamine, or citric acid, as needed. Any additional components required or desired in the first composition can be routinely chosen by one skilled in the art, for example, sea salt, natural oils, vitamins (e.g., tocopheryl acetate), panthenol, emulsifiers, film formers, opacifiers, pearlizing agents, and/or fragrances.

The first composition can be in the form of a solution, dispersion, water-in-oil emulsion, or oil-in-water emulsion, for example. The first composition also can be formulated as a liquid, lotion, cream, gel, foam, or aerosol spray, for example. Preferred first compositions are formulated as a liquid or lotion.

The following are typical examples of hair color revitalizing compositions that can be utilized as the first composition of the present kit and method.

Hair Color Revitalizer A (Shampoo)

| | Amount Wt % |
|---|---|
| Ingredient (INCI Name) | (as added) |
| Water | 67.25 |
| PEG-3 Distearate (20% active) | 12.50 |
| Sodium Laureth Sulfate (70% active) | 8.80 |
| Cocamidopropyl Betaine (30% active) | 7.00 |
| Sodium Chloride | 1.13 |
| PEG-200 Hydrogenated Glyceryl Palmitate (56% active) | 1.00 |
| Denatured Ethanol | 0.65 |
| Fragrance (65% active) | 0.50 |
| Polyquaternium-10 | 0.20 |
| Methylparaben | 0.20 |
| Disodium EDTA | 0.13 |
| Propylparaben | 0.10 |
| (Mallow) Flower Extract (1.6% active) | 0.10 |
| Prunus Armeniaca (Apricot) Kernal Oil | 0.10 |
| Polysorbate 20 (88% active) | 0.10 |
| Sodium Benzoate | 0.08 |
| Tocopheryl Acetate | 0.05 |
| Sea Salt | 0.05 |
| Panthenol | 0.05 |
| Acid Violet 43 | 0.02 |

Hair Color Revitalizer B (Shampoo)

| | Amount Wt % |
|---|---|
| Ingredient (INCI Name) (as added) | (as added) |
| Water | 60.52 |
| PEG-3 Distearate (20% active) | 12.50 |
| Sodium Laureth Sulfate (70% active) | 10.00 |
| Cocamidopropyl Betaine (30% active) | 8.00 |
| PEG-120 Methyl Glucose Trioleate (40% active) | 4.00 |
| Sodium Chloride | 1.02 |
| Phenoxyethanol | 0.70 |
| Denatural Ethanol | 0.65 |
| Fragrance (65% active) | 0.50 |
| 3-nitro-p-hydroxyethylaminophenol | 0.40 |
| Polyquaternium-10 | 0.20 |
| Methylparaben | 0.20 |
| Sodium Hydroxide | 0.17 |
| HC Red No. 10 (70% active) | 0.15 |
| Propylparaben | 0.10 |
| Punica Granatum Extract (12.2% active) | 0.10 |
| Potassium Phosphate | 0.10 |
| Apricot Kernel Oil | 0.10 |
| Polysorbate 20 (88% active) | 0.10 |
| Sodium Benzoate | 0.09 |
| HC Red No. 3 | 0.08 |
| Disodium EDTA | 0.08 |
| Tetrasodium EDTA Tetrahydrate (82% active) | 0.06 |
| Tocopheryl Acetate | 0.05 |
| Sea Salt | 0.05 |
| Panthenol | 0.05 |
| 2-Amino-6-chloro-4-nitrophenol | 0.04 |

Hair Color Revitalizer C (Shampoo)

| Ingredient (INCI Name) | Amount Wt % (as added) |
|---|---|
| Water | 67.43 |
| PEG-3 Distearate (20% active) | 12.50 |
| Sodium Laureth Sulfate (70% active) | 8.80 |
| Cocamidopropyl Betaine (30% active) | 7.00 |
| Sodium Chloride | 0.51 |
| PEG-120 Methyl Glucose Trioleate | 0.70 |
| (40% active) | |
| Denatural Ethanol | 1.00 |
| Fragrance (65% active) | 0.50 |
| Polyquaternium-10 | 0.20 |
| Methylparaben | 0.20 |
| Sodium Hydroxide | 0.17 |
| Propylparaben | 0.10 |
| Potassium Phosphate | 0.10 |
| Bisabolol | 0.10 |
| Apricot Kernel Oil | 0.10 |
| Polysorbate 20 (88% active) | 0.10 |
| Hydroxyethyl-2-nitro-p-toluidine | 0.08 |
| Sodium Benzoate | 0.08 |
| Disodium EDTA | 0.08 |
| Tetrasodium EDTA Tetrahydrate (82% active) | 0.06 |
| Tocopheryl Acetate | 0.05 |
| Sea Salt | 0.05 |
| Panthenol | 0.05 |
| 2-Hydroxyethyl picramic acid | 0.04 |
| HC Red No. 10 (70% active) | 0.01 |

Hair Color Revitalizer D (Conditioner)

| Ingredient (INCI Name) | Amount Wt % (as added) |
|---|---|
| Dimethicone | 0.50 |
| Water | 85.00 |
| Apricot Kernel Oil | 0.10 |
| Sea Salt | 0.05 |
| Panthenol | 0.50 |
| Denatured Alcohol (96% active) | 2.00 |
| Cetearyl Alcohol | 7.00 |
| Cetrimonium Chloride | 2.20 |
| Petrolatum | 1.35 |
| Tocopheryl Acetate | 0.10 |
| Polysorbate 20 (88% active) | 0.10 |
| Fragrance (65% active) | 0.50 |
| Mallow Flower Extract (1.6% active) | 0.06 |
| Disperse Violet 1 | 0.0025 |
| Propylparaben | 0.20 |
| Methylparaben | 0.30 |
| Sodium Hydroxide/Citric Acid | as needed |

Hair Color Revitalizer E (Conditioner)

| Ingredient (INCI Name) | Amount Wt % (as added) |
|---|---|
| Basic Blue 99 | 0.015 |
| Basic Brown 16 | 0.01 |
| Basic Red 76 | 0.02 |
| Dimethicone | 0.50 |
| Water | 84.75 |
| Apricot Kernel Oil | 0.10 |
| Sea Salt | 0.05 |
| Panthenol | 0.50 |
| 3-Nitro-p-hydroxyethylaminephenol | 0.035 |
| Denatured Alcohol (95% active) | 2.00 |
| Cetearyl Alcohol | 7.00 |
| Cetrimonium Chloride (50% active) | 2.20 |
| Petrolatum | 1.35 |
| Tocopherol Acetate | 0.10 |
| Polysorbate 20 (88% active) | 1.00 |
| Fragrance (65% active) | 0.50 |
| Cinnamon Bark Extract (3% active) | 0.10 |
| Potassium Phosphate | 0.10 |
| 2-Amino-6-chloro-4-nitrophenol | 0.045 |
| Methylparaben | 0.30 |
| Propylparaben | 0.20 |
| Sodium Hydroxide | as needed |

Hair Color Revitalizer F (Conditioner)

| Ingredient (INCI Name) | Amount Wt % (as added) |
|---|---|
| Basic Brown 16 | 0.003 |
| Basic Brown 17 | 0.004 |
| Dimethicone | 0.50 |
| Water | 84.85 |
| Apricot Kernel Oil | 0.10 |
| Sea Salt | 0.05 |
| Panthenol | 0.50 |
| HC Red No. 10 | 0.0035 |
| HC Red No. 11 | 0.0015 |
| Denatured Alcohol (95% active) | 2.00 |
| Hydroxyethyl-2-nitro-p-toluidine | 0.008 |
| Cetearyl Alcohol | 7.00 |
| Bisabolol | 0.10 |
| Cetrimonium Chloride (50% active) | 2.20 |
| Petrolatum | 1.35 |
| Tocopherol Acetate | 0.10 |
| Polysorbate 20 (88% active) | 0.10 |
| Fragrance (65% active) | 0.50 |
| Potassium Phosphate | 0.10 |
| Methylparaben | 0.30 |
| Propylparaben | 0.20 |
| Sodium Hydroxide | as needed |

Hair Revitalizer G (Conditioner)

| Ingredient (INCI Name) | Amount Wt % (as added) |
|---|---|
| Dimethicone | 0.50 |
| Water | 84.70 |
| Apricot Kernel Oil | 0.10 |
| Sea Salt | 0.05 |
| Panthenol | 0.50 |
| HC Red No. 10 | 0.027 |
| HC Red No. 11 | 0.012 |
| 3-Nitro-p-hydroxyethylaminephenol | 0.10 |
| Denatured Alcohol (95% active) | 2.00 |
| Hydroxyethyl-2-nitro-p-toluidine | 0.016 |
| Cetearyl Alcohol | 7.00 |
| Cetrimonium Chloride (50% active) | 2.20 |
| Petrolatum | 1.35 |
| Tocopherol Acetate | 0.10 |
| Polysorbate 20 (88% active) | 0.10 |
| Fragrance (65% active) | 0.50 |
| Potassium Phosphate | 0.10 |
| Methylparaben | 0.30 |
| Propylparaben | 0.20 |
| Sodium Hydroxide | as needed |

### Second Hair Glossing Composition

The second composition of the presently claimed kit is topically applied to the hair of an individual after the first composition of the kit is topically applied to the hair. The second composition is designed to impart gloss to the hair. In accordance with the present invention, it has been found that by applying the second glossing composition to the hair after the first hair revitalizing composition, a synergistic effect is observed in that the color of the hair is dramatically improved compared to a hair color when only a first hair color revitalizing composition is applied to the hair.

The second glossing composition typically is in the form of a nonaqueous liquid for ease of application to the hair, such as a spray or aerosol. An essential ingredient of the second composition is a compound, or mixture of compounds, capable of imparting a gloss to contacted hair. Typically, the glossing compound is a silicone compound, and more preferably a blend of silicones, for example, a blend of a volatile and a nonvolatile silicone.

The identity of the silicone glossing agent is not particularly limited as long as the silicone is capable of imparting a shine to treated hair. Accordingly, the silicone glossing agent can be a silicone compound disclosed above as an conditioning agent that may be present in the first composition of the present kit. It should be noted that the first composition optionally contains a low amount of a silicone conditioning agent, if any. The second hair glossing composition contains a substantially greater amount of a silicone glossing compound, in particular about 40% to about 95%, preferably about 45% to about 90%, about 40% to about 85%, or about 50% to 80%, by weight, of a silicone or a mixture thereof.

In particular, the silicone glossing agent can be a silicone oil, such as the polyalkyl and polyaryl siloxanes having the following formulae:

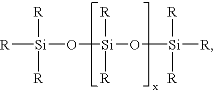

wherein R is aliphatic, preferably alkyl or alkenyl, or aryl, R can be substituted or unsubstituted, and x is an integer from 1 to about 8,000;
and the cyclic polysiloxane having the following formula

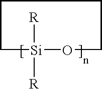

wherein R is as defined above, and n is a number from 3 to about 7, preferably 3, 4, or 5. Suitable unsubstituted R groups include, but are not limited to, alkoxy, aryloxy, alkaryl, arylalkenyl, alkamino, and ether-substituted, hydroxyl-substituted, and halogen-substituted aliphatic and aryl groups.

Preferred silicones used in the second glossing composition are dimethicones, dimethiconols, cyclomethicones, and mixtures thereof. A preferred silicone is a blend of a dimethiconol with a dimethicone and/or a cyclomethicone.

The second composition also comprises a cosmetically-acceptable nonaqueous carrier. The carrier can be an alcohol, a hydrocarbon, or a mixture thereof, for example. Preferably, the carrier is volatile such that after application to the hair, the carrier evaporates leaving the silicone glossing agent on the hair. Nonlimiting examples of carriers include, but are not limited to, ethanol, isododecane, and mixtures thereof.

The second composition of the present invention also can contain additional optional ingredients, for example, a fragrance and/or ultraviolet absorber. In particular, the UV absorber can be octyl methoxycinnamate, octocrylene, avobenzone, octyl salicylate, or a mixture thereof. Other ingredients that are conventionally used in a glossing composition also can be present, as long as the optional ingredient does not adversely affect the efficacy of the glossing composition, the kit, or the present method. Examples of other optional ingredients include, but are not limited to, fragrances, hair conditioners, vitamins, and natural oils.

The following are typical examples of hair glossing compositions that can be utilized as the second composition of the present kit and method.

Hair Gloss A

| Ingredient (INCI Name) | Amount Wt % |
|---|---|
| Denatured Ethanol | 5.0 |
| Fragrance | 0.6 |
| Cyclomethicone¹⁾ | 49.1 |
| Cyclomethicone (and) Dimethiconol²⁾ | 45.0 |
| Tocopheryl Acetate | 0.1 |
| Apricot Kernel Oil | 0.1 |
| Prunus Dulcis (Almond) Oil | 0.1 |

¹⁾DOW FLUID 244, available from Dow Corning Corp, Midland, MI; and
²⁾DOW CORNING DC1401 Fluid, available from Dow Corning Corp.

Hair Gloss B

| Ingredient (INCI Name) | Amount Wt % |
|---|---|
| Cyclomethicone (and) Dimethiconol²⁾ | 50.00 |
| Cyclomethicone¹⁾ | 6.50 |
| Denatured Ethanol | 6.75 |
| Water | 0.36 |
| Ethylhexyl Methoxycinnamate | 0.20 |
| Dimethicone (and) Dimethiconol³⁾ | 12.00 |
| Disiloxane⁴⁾ | 14.56 |
| Caprylic/Capric Triglyceride | 9.44 |
| Tocopheryl Acetate | 0.20 |

³⁾DOW CORNING DC1403 FLUID, available from Dow Corning Corp; and
⁴⁾DOW CORNING DC200 Fluid, available from Dow Corning Corp.

Hair Gloss C

| Ingredient (INCI Name) | Amount Wt % |
|---|---|
| Cyclopentasiloxane⁵⁾ | 19.89 |
| Disiloxane (0.65 centistoke)⁶⁾ | 50.00 |
| Dimethicone⁷⁾ | 10.00 |
| Denatured Ethanol | 20.00 |
| Fragrance | 0.05 |
| Panthenol | 0.05 |
| Ethylhexyl Methoxycinnamate | 0.01 |

⁵⁾DOW FLUID 245, available from Dow Corning Corp;
⁶⁾DOW CORNING 200 FLUID, available from Dow Corning Corp; and
⁷⁾Siliconoel 20 M PA.S.

### Method

A hair coloring revitalizing kit of the present invention is particularly useful as a multistep hair treating product. The kit is used in a method to revitalize the color of mammalian, and particularly human, hair, wherein the first hair color revitalizing composition is applied to the hair, followed by a sequential application of the second hair glossing composition. The present method also can include additional hair treating steps which utilize additional compositions that provide an additional benefit to the hair, e.g., a hair shampoo, a hair conditioner, a hair spray, a mousse, or a hair gel. These additional compositions can be applied to the hair prior to the first composition, after the second composition, or between the first and second compositions. In preferred embodiments of the invention, the first and second compositions of the kit are applied to the hair sequentially without any intervening hair product applications.

The method of treating hair using the compositions in a kit of the present invention includes a preferred, but optional, step of shampooing the hair prior to applying the first composition to the hair. After an optional shampooing, the first composition of the kit is applied to wetted hair in a manner such that the first composition is evenly spread throughout the hair. After allowing the composition to remain on the hair for a sufficient time to dye the hair to a desired degree, e.g., about 2 to about 60 minutes, the first composition is rinsed from the hair. Then, the second glossing composition of the kit is applied to the hair in a manner that provides uniform covering of the hair by the second composition. The second composition is not rinsed from, but is allowed to remain on, the hair.

After the hair dries, the color revitalized hair can be subjected to a normal hair care routine. The compositions of the kit are reapplied to the hair as needed, such as daily or weekly, to maintain a desired hair color. In accordance with an important feature of the present invention, the second glossing composition always is applied shortly after the first haircolor revitalizing composition is applied to the hair. In one embodiment of the invention, the second glossing composition is applied to the hair more frequently, e.g., daily, and the first composition is applied on as needed or as desired regimen, typically weekly. As demonstrated hereafter, the second glossing composition acts synergistically with the first composition to improve hair color to a greater degree than expected when using the first and second compositions alone.

The following demonstrates the synergistic effect of applying a second hair glossing composition to hair that has been treated with a first color revitalizing composition. It has been found that the glossing composition provides more than merely a light filtering effect, but rather adds to the vibrancy of the hair color and provides a deeper hair color.

More particularly, to demonstrate the synergistic effect provided by a sequential application of the first and second compositions of the present kit, hair switches first were treated with a commercial hair color revitalizer, i.e., Nicky Clarke Colour Gloss. After treatment, the hair switches were measured for color readings.

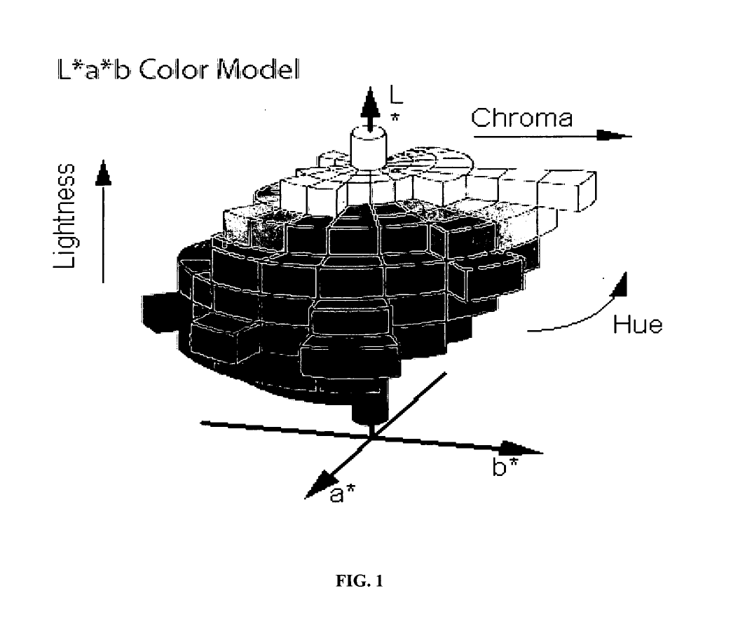

In particular, the L, a, b, C, and h color readings of hair switches were measured using a Minolta Spectrophotometer CM-3700d. The L*a*b* color space (also referred as CIELab) is a well known and used color space for measuring colors and determining color differences. The system was defined to provide a uniform color space where equal changes in a color axis corresponds to an equally perceived color difference. In the CIELab space, L* represents lightness, and a* and b* are the chromaticity co-ordinates. The a* and b* axis are defined using a concept of opponent colors, where +a* is the red direction, −a* is the green direction, +b* is the yellow direction, and −b* is the blue direction. a* and b* values are equal to 0 in the center which is achromatic, and increase away from the center. C*, the chroma coordinate, is the perpendicular distance from the lightness axis (more distance being more chroma or movement away from gray tones). h* is the hue angle expressed in degrees, with 0° being a location of the +a* (red) axis, then continuing to 90° for the +b* axis, 180° for −a*, 2700 for −b*, and back to 3600=0°. Movement along the h* plate denotes color change. The CIELab colorspace is visually depicted in FIG. 1.

When measuring the color reading of a hair switch, the medium area view (MAV) aperature (8 mm diameter) is attached the CM-3700d instrument aperature. The instrument was calibrated daily to black and white standards. Each switch was measured four times on each side, for a total of 8 eight readings per single switch reading. Ten switch readings were conducted per switch. The first measurement on either side was taken at the top of the switch, with each subsequent reading being one-quarter farther down the mid-line of the switch. The last reading was taken just above the tips of the hair. L, a, b, C, h measurements were exported to excel text files.

In this test, the hair switches were of fine quality, as opposed to virgin switches. All switches were brunette in color. Lot switches first were shampooed and numbered. The initial shampooing was performed, as follows, to establish a color baseline.

### Baseline Wash

### Switch Treatment/Dosage:

Water temperature and flow: 100° F. at 1.5 GPM (gallons per minute).

### Baseline Dose per Switch

0.1 ml of Pantene Purity Shampoo/1 g switch weight (i.e., conventional dose)

### Equipment and Materials:

Hair switches (4 per group)

### Pantene Purity Shampoo

Nitrile gloves

### 3 ml Syringes

### Protocol:

### Switch Shampoo Treatment

### Put on Gloves

Thoroughly wash switch with Pantene Purity Shampoo, then thoroughly rinse with water for 1 minute
Hang switch on switch rack by binder clip
Milk excess water from switch, then towel dry
Oven dry switch until completely dry
Repeat process for each switch
Initial L, a, b, C, h color readings were measured using a Minolta Spectrophotometer CM-3700d, as described above, to establish baseline readings for each switch. The baseline readings were used to reduce switch variability even further by creating clusters of four switches per cluster based upon the initial L, a, b, C, h color readings.
Each switch cluster then was treated according to the following regimen:
1 control switch (no treatment)
1 revitalizer treated switch (0.2 ml/100 g hair—commercial dose)
1 gloss treated switch (0.45 ml/100 g hair—commercial dose)
1 revitalizer and gloss treated switch (using above dosages).
The protocols for the revitalizer and gloss switch treatments using Nicky Clarke Color
Revitalizer and/or Gloss Formula were as follows.

### Equipment and Materials:

Hair switches (4 per cluster)

### Nicky Clarke In-Bath Color Revitalizer

### Nicky Clarke Color Gloss

Nitrile gloves
5 ml syringes
1 ml syringe
Hair brush/comb
Hair drying oven chamber

### Switch Treatment/Dosage:

Water temperature and flow: 100° F. at 1.5 GPM

### Revitalizer Dose per Switch

0.2 ml of revitalizer product per 100 hair switch grams (commercial dose).

### Gloss Dose per Switch

0.75 of gloss product per 100 hair switch grams

### Protocol:

### Color Revitalizer Treatment

### Put on Gloves

Thoroughly wet hair for 30 seconds
Apply Nicky Clarke Color Revitalizer, massage into hair for 30 seconds ensuring that each hair strand has been treated. Allow revitalizer to remain in the hair for 5 minutes.
Rinse the treated hair switch thoroughly for 1 minute.
Hang hair switch on switch rack by binder clip
Milk excess water from switch
Remove gloves
Oven dry switch for 60 minutes
Repeat process for each switch treated with the color revitalizer product

### Gloss Treatment

Dispense product onto gloved, closed fingered hand, rub hands together, and distribute gloss product evenly throughout the dry switch, ensuring that each hair strand has been treated, top to bottom
Change gloves between each gloss application.
Repeat process for each switch treated with the color gloss product

After subjecting the hair switches to either or both of the color revitalizer and gloss treatments, the L, a, b, C, h color readings were measured using a Minolta Spectrophotometer CM-3700d instrument on all switches as described above.

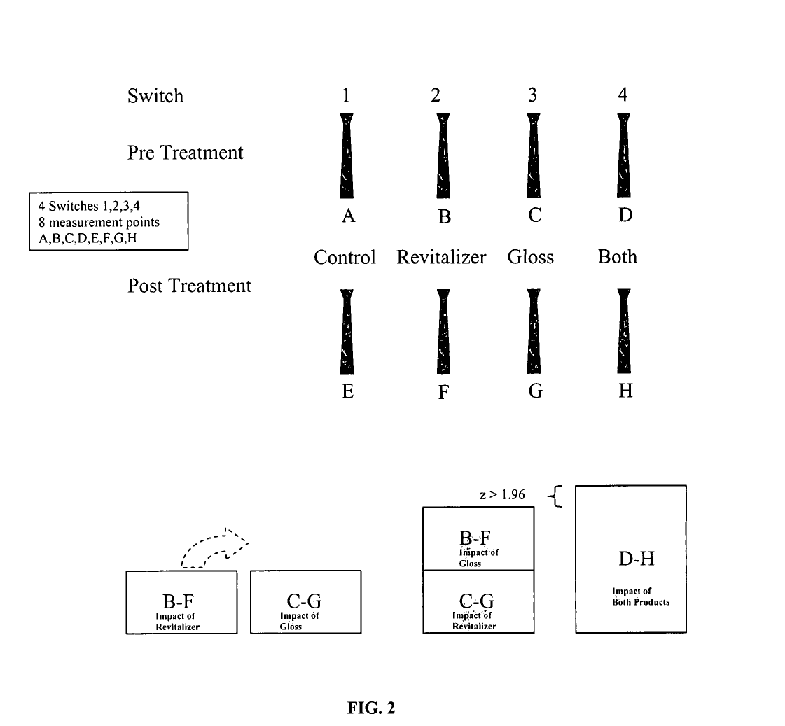

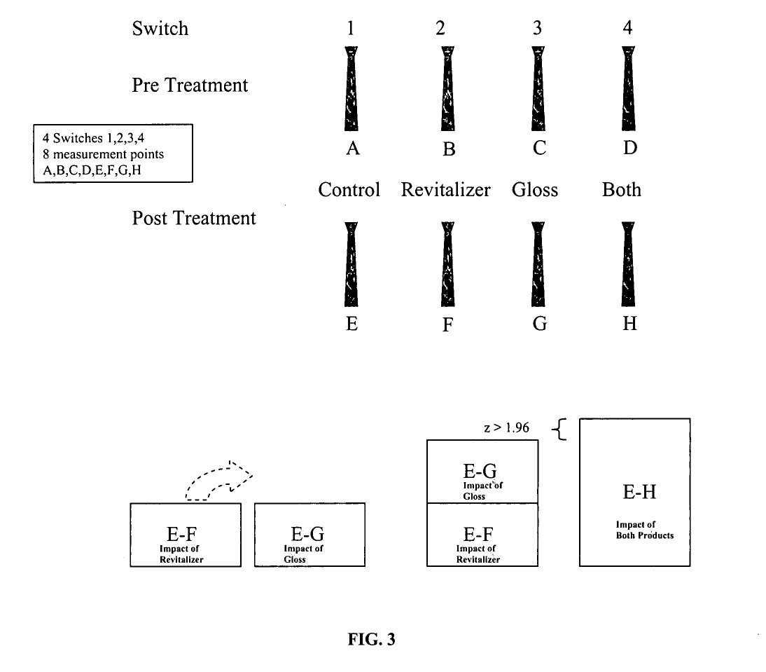

Each treated switch was assessed by comparing L, a, b, C, h color readings to: the previous baseline reading for that specific switch (i.e., before and after treatment measurements), and the designated control switch within the cluster. More particularly, FIGS. 2 and 3 illustrate the new and unexpected, and synergistic, results provided by the present invention.

FIG. 2 shows four hair switches (1, 2, 3, and 4) that were measured for color readings both pretreatment and post-treatment. Eight measurement points for color readings were taken, i.e., points A through H. Switch 1 (no treatment) is a control determined from measurements A and E. Switch 2 (revitalizer treatment) demonstrates the effect of the revitalizer alone, i.e., the differences between measurement B and F or B-F. Switch 3 (gloss treatment) demonstrates the effect of the gloss alone, i.e., the difference between measurement C and G or C-G. Switch 4 (revitalizer and gloss treatment) demonstrates the effect of applying both the revitalizer and the gloss to the hair switch, i.e., the difference between measurement D and H, or D-H.

It is expected that the combined effect of the revitalizer and gloss treatments would be the additive effect of measurement differences B-F and C-G. However, the impact of both treatments (D-H) was statistically much greater than the additive effect of measurements B-F and C-G. This difference was statistically significant (Z>1.96) such that a synergistic effect was provided by treating the hair first with a revitalizing composition, then with a glossing composition.

Another comparison of color measurements confirmed this observed synergistic effect. In FIG. 3, the post-treatment measurements were compared. The E-F color difference is the impact of the revitalizer treatment. The E-G color difference is the impact of the gloss treatment. The E-H color difference is the impact of both the revitalizer and gloss treatments. Again, it is expected that a sum of the E-F and E-G color differences would be the color difference after both treatments. However, the actual color difference after both treatments was E-H, which was statistically much greater (Z>1.96) than the sum of color differences E-G and E-H. The present method therefore again demonstrated the synergistic effect of sequential hair revitalizer and hair gloss treatments.

What is claimed is:

1. A hair treatment kit suitable for application as a multistep hair color revitalizing product, said kit comprising:
a packaged first composition comprising a temporary dye, a semipermanent hair dye, or a mixture thereof, and a cosmetically-acceptable carrier;
a packaged second composition comprising a silicone hair glossing agent and a cosmetically-acceptable carrier; and
labeling comprising indicia instructing a topical application of the second composition to hair after a topical application of the first composition to the hair.

2. The kit of claim 1 further comprising one or more of a packaged hair shampoo composition, conditioner composition, gel, mousse, and hair spray.

3. The kit of claim 1 comprising a plurality of packaged first compositions.

4. The kit of claim 1 wherein the first composition further comprises a surfactant, a hair conditioning agent, or both.

5. The kit of claim 1 wherein the dye is selected from the group consisting of a direct dye, a disperse dye, an acid dye, a basic dye, and mixtures thereof.

6. The kit of claim 1 wherein the temporary dye is selected from the group consisting of a monoazo dye, a diazo dye, a polyazo dye, a quinoline dye, an anthraquinone dye, a triphenylmethane dye, a naphthoquinoneimine dye, and mixtures thereof.

7. The kit of claim 1 wherein the temporary dye is selected from the group consisting of Acid Yellow 3, Acid Orange 7, Acid Orange 24, Direct Red 80, Food Red 1, Acid Red 33, Acid Violet 43, Acid Blue 9, Acid Green 25, Direct Black 57, Basic Yellow 57, Basic Yellow 87, Basic Red 76, Basic Red 51, Basic Blue 99, Basic Brown 16, Basic Brown 17, Acid Yellow 1, Acid Yellow 9, Disperse Yellow 3, Disperse Yellow 1, Basic Violet 1, Basic Violet 3, FD&C Blue No. 1, FD&C Red No. 4, FD&C Yellow No. 5, FD&C Yellow No. 6, FD&C Green No. 3, FD&C Red No. 40, D&C Green No. 3, D&C Orange No. 5, D&C Red No. 6, D&C Red No. 7, D&C Red No. 22, D&C Red No. 28, D&C Red No. 30, D&C Red No. 33, D&C Red No. 34, D&C Red No. 36, D&C Orange No. 4, D&C Yellow No. 10, D&C Green No. 8, Ext D&C Violet No. 2, Ext. D&C Yellow No. 7, salts thereof, and mixtures thereof.

8. The kit of claim 1 wherein the semipermanent dye comprises a nitrophenylenediamine, a nitroaminephenolic ether, or a mixture thereof.

9. The kit of claim 1 wherein the semipermanent dye is selected from the group consisting of 2-hydroxyethyl picramic acid, 4-nitro-m-phenylenediamine, HC Yellow 10, 4-nitro-o-phenylenediemine, HC Blue 7, HC Yellow 2, HC Yellow 5,2-nitro-p-phenylenediamine, HC Red 14, HC Red 10, HC Red 11, HC Red 1, HC Red 3, HC Red 13, N,N-bis(2-hydroxyethyl)-2-nitro-p-phenylenediamine, HC Violet 2, HC Blue 2,2-amino-4-nitrophenol, 2-amino-5-nitrophenol, HC Yellow 4, HC Yellow 9,2-nitro-5-glycerylmethylaniline, 2-amino-3-nitrophenol, 2-nitro-N-hydroxyethyl-p-anisidine, HC Orange 2, HC Orange 3,4-amino-3-nitrophenol, 4-hydroxypropylamino-3-nitrophenol, 3-nitro-p-hydroxyethylaminophenol, Disperse Red 15, Disperse Red 11, Disperse Violet 1, Disperse Violet 4, Disperse Blue 3, HC Blue 14, HC Yellow 6, HC Yellow 15, HC Yellow 1, HC Orange 1, HC Yellow 7, Disperse Black 9, and mixtures thereof.

10. The kit of claim 1 wherein the temporary dye, the semipermanent dye, or both is selected from the group consisting of Acid Black 131, Acid Blue 62, Acid Orange 3, Acid Red 35, Acid Red 52, 2-amino-6-chloro-4-nitrophenol, 4-amino-2-hydroxytoluene, 2-amino-3-nitrophenol, m-aminophenol, o-aminophenol, p-aminophenol, Basic Blue 6, Basic Blue 9, Basic Blue 41, Basic Brown 4, Basic Red 22, Basic Yellow 11, N,N-bis(2-hydroxyethyl)-p-phenylenediamine sulfate, bismuth citrate, 2-chloro-p-phenylenediamine, 2,4-diaminodiphenylamine, 4,4′-diaminodiphenylamine, 2,4-diaminophenol, 2,4-diaminophenoxyethanol, 2,6-diaminopyridine, N,N-diethyl-m-aminophenol, N,N′-dimethyl-N-hydroxyethyl-3-nitro-p-phenylenediamine, dimethyl o-toluidine, 2,5-dinitrophenol, Direct Black 51, Direct Red 23, Direct Red 81, Direct Yellow 48, Direct Violet 48, Direct Yellow 12, Disperse Blue 1, HC Blue No. 4, HC Blue No. 5, HC Yellow No. 3, HC Yellow No. 5, henna, hydroxybenzomorpholine, N-hydroxyethyl-2-amino-4-hydroxytoluene sulfate, 2-hydroxyethylamino-5-nitroanisole, lead acetate, N-methoxyethyl-p-phenylenediamine, 2-methoxyethyl-p-phenylenediamine, 2-methoxyethyl-p-phenylenediamine, 2-methoxy-p-phenylenediamine, 4-methoxytoluene-2,5-diamine, 3-methylamino-4-nitrophenoxyethanol, p-methylaminophenol, 2-methyl-5-hydroxyethylaminophenol, N-methyl-2-nitro-p-phenylenediamine, 2-methylresorcinol, 1,5-naphthalenediol, 2,3-naphthalenediol, 2,7-naphthalenediol, 1-naphthol, 2-naphthol, 3-nitro-4-aminophenoxyethanol, 2-nitro-N-hydroxyethyl-p-anisidine, m-phenylenediamine, p-phenylenediamine, phenyl methylpyrazolone, N-phenyl-p-phenylenediamine, phloroglucinol, picramic acid, Pigment Blue 15, Pigment Blue 15:2, Pigment Green 7, Pigment Red 112, Pigment Violet 19, Pigment Yellow 1, Pigment Yellow 3, Pigment Yellow 12, Pigment Yellow 13, Pigment Yellow 73, pyrocatechol, pyrogallol, resorcinol, sodium picramate, sodium sulfanilate, Solvent Black 3, Solvent Blue 35, Solvent Red 24, Solvent Yellow 44, toluene-2,5-diamine, toluene-3,4-diamine, salts thereof, and mixtures thereof.

11. The kit of claim 1 wherein the first composition comprises at least one temporary dye and at least one semipermanent dye.

12. The kit of claim 1 wherein the first composition is in the form of a hair shampoo, a hair conditioner, a hair shampoo/conditioner, a hair spray, a mousse, or a hair gel.

13. The kit of claim 1 wherein the silicone hair glossing agent of the second composition comprises a dimethicone, a cyclomethicone, a dimethiconol, or mixtures thereof.

14. The kit of claim 1 wherein the second composition further comprises one or more of an ultraviolet absorber, a hair conditioner, a natural oil, and a fragrance.

15. The kit of claim 1 comprising a plurality of packaged first compositions.

16. The kit of claim 1 comprising a plurality of packaged second compositions.

17. The kit of claim 1 further comprising a packaged composition of one or more hair shampoo, hair conditioner, hair spray, mousse, and hair gel.

18. The kit of claim 1 further comprising a container for storing the packaged first composition and the packaged second composition.

19. A method of revitalizing hair color comprising:
(a) applying a first composition comprising a temporary dye, a semipermanent dye, or mixture thereof to hair,
(b) then apply a second composition comprising a silicone glossing agent to the hair.

20. The method of claim 19 further comprising shampooing the hair prior to applying the first composition to the hair.

21. The method of claim 19 wherein the first composition and the second composition are applied to the hair sequentially and absent an intervening application of a third hair treating composition to the hair.

22. The method of claim 19 wherein the first composition is applied at seven to ten day intervals.

23. The method of claim 22 wherein the second composition is applied to the hair when the application of the first composition is completed.

24. The method of claim 22 wherein the second composition is applied to the hair periodically between applications of the first composition.
